(19) United States
(12) Patent Application Publication
(10) Pub. No.: US 2014/0312060 A1
(43) Pub. Date: Oct. 23, 2014

(54) DOSING SPOUT AND SYSTEM

(71) Applicants: Richard B. Heatherly, Charleston, SC (US); Michael Morton, Charleston, SC (US); David Nichols-Roy, Escondido, CA (US)

(72) Inventors: Richard B. Heatherly, Charleston, SC (US); Michael Morton, Charleston, SC (US); David Nichols-Roy, Escondido, CA (US)

(21) Appl. No.: 14/321,083

(22) Filed: Jul. 1, 2014

Related U.S. Application Data
(63) Continuation-in-part of application No. 13/091,788, filed on Apr. 21, 2011, now Pat. No. 8,783,512.
(60) Provisional application No. 61/327,318, filed on Apr. 23, 2010.

(51) Int. Cl. B67D 3/00

(52) U.S. Cl. CPC B67D 3/0041; B67D 3/0051; B67D 3/0061; B67D 3/0077
USPC 222/23; 222/52; 222/478

(57) ABSTRACT

A system for inventory control, verification and accounting for liquids dispensed in smaller doses or portions from larger containers. The system has multiple spouts, each of which controls flow of a liquid from a container in predetermined dosage size. Each dosing spout permits flow of liquid through a liquid outlet tube when the angle of the container is changed such as by tilting for pouring. After a predetermined time, the air inlet tube is closed, which terminates flow of the liquid through the liquid outlet tube. Controls and signaling devices operate the dosing spout, and wireless communications devices and processors record uses of the system of dosing spouts.

This application is a continuation in part of application Ser. No. 13/091,788 filed Apr. 21, 2011, which claimed the benefit of Provisional Application Ser. No. 61/327,318 filed Apr. 23, 2010, and the benefit thereof is claimed hereby.

### FIELD OF THE INVENTION

This invention relates to liquid dosing generally, and is more particularly directed to a spout for liquid containers that controls dosing. The invention provides a system that assists in inventory control.

### BACKGROUND OF THE INVENTION

Accurate inventory control is critical to the success of businesses that sell from inventory. Sales of goods in the form of liquids create unique problems in inventory control, especially where the liquid is sold in relatively small quantities that are dispensed from a larger container. Specific examples are liquors and medicines that are dispensed in small portions or doses from containers. In the case of both liquors and medicines, the liquid may be dispensed from a bottle or similar container in relatively small quantities. However, even a small quantity of the liquid has significant value. In the case of medicines, not only is the cost of each dose a factor, but dispensary control of the drug is required.

There is a need for a device that can be attached to existing containers that will accurately control dosages that are dispensed from containers such as bottles. The device should also report and record the number and size of the dosages dispensed. The dosing information may be compared with charges to the customer or patient to assist in preventing inventory shrinkage, or other loss of inventory due to waste, theft or misdirection of the liquid.

### SUMMARY OF THE INVENTION

The present invention is a dosing spout for liquid containers, and a system for inventory control, verification and accounting for liquids dispensed in smaller doses or portions from larger containers. The device controls flow of a liquid from a container in predetermined dosage size by an air inlet tube that permits flow of liquid through a liquid outlet tube when the container is tilted. After a predetermined time, the air inlet tube is closed, which terminates flow of the liquid through the liquid outlet tube. The time interval during which the air inlet tube is open is correlated with the viscosity of the liquid in the container so that a predetermined dosage is dispensed through the dosing spout.

The dosing spout has controls and signaling devices that indicate positioning of the dosing spout on, and its removal from, a container, and that indicate when liquid is available to the liquid outlet tube. Information regarding replacement of an empty container with a full container, and the number of doses and/or quantity dispensed, is transmitted from the dosing spout to a central processing unit by wireless communication.

### DESCRIPTION OF THE DRAWINGS

FIG. 1A and FIG. 1B are exemplary schematics showing elements of an embodiment of the dosing spout, and elements of the inventory monitoring and control system.

FIG. 2 shows an embodiment of a preferred embodiment of the dosing spout.

FIG. 3 shows the dosing spout of FIG. 3, emphasizing the bottom of the dosing spout, which engages a container.

FIG. 4 shows an exploded view of the dosing spout of FIG. 3.

FIG. 5 shows the internal mechanical mechanism of a preferred embodiment of the dosing spout.

FIG. 6 shows an additional view of the internal mechanism of the dosing spout.

FIG. 7 shows an additional view of the internal mechanism of the dosing spout.

FIGS. 8A, 8B, 8C and 8D show an additional embodiment of the dosing control mechanism for a spout according to the invention, with the figures showing opening and closing of the air inlet tube and liquid outlet tube as the motor rotates through 360°.

FIG. 9 is an exploded view of the dosing control mechanism of FIGS. 8A, 8B, 8C and 8D.

FIG. 10 is a sectioned view of the dosing control mechanism of FIG. 9.

FIG. 11 is another sectioned view of the dosing control mechanism of FIG. 9.

FIG. 12 is an isolation of a cam that may be used with the invention.

FIG. 13 is a sectioned view of an embodiment of the spout showing internal components of the liquid outlet tube.

### DETAILED DESCRIPTION OF PREFERRED EMBODIMENTS

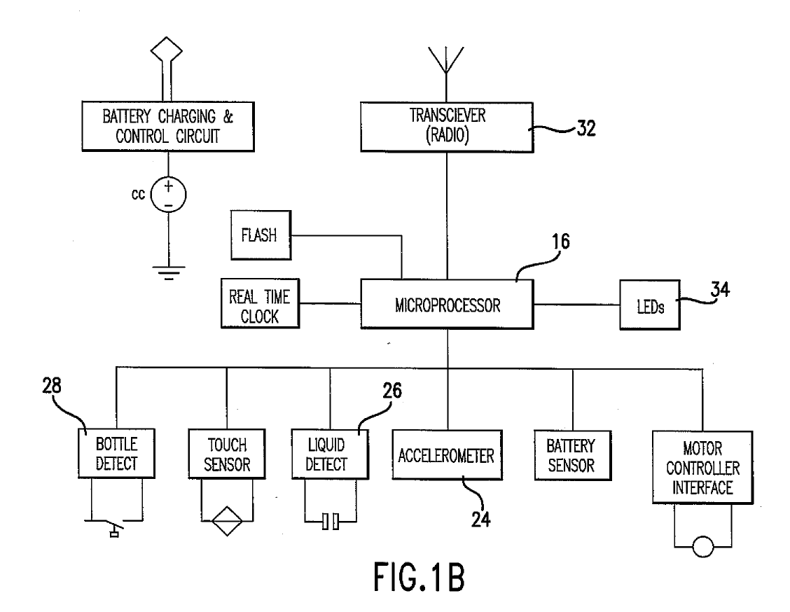

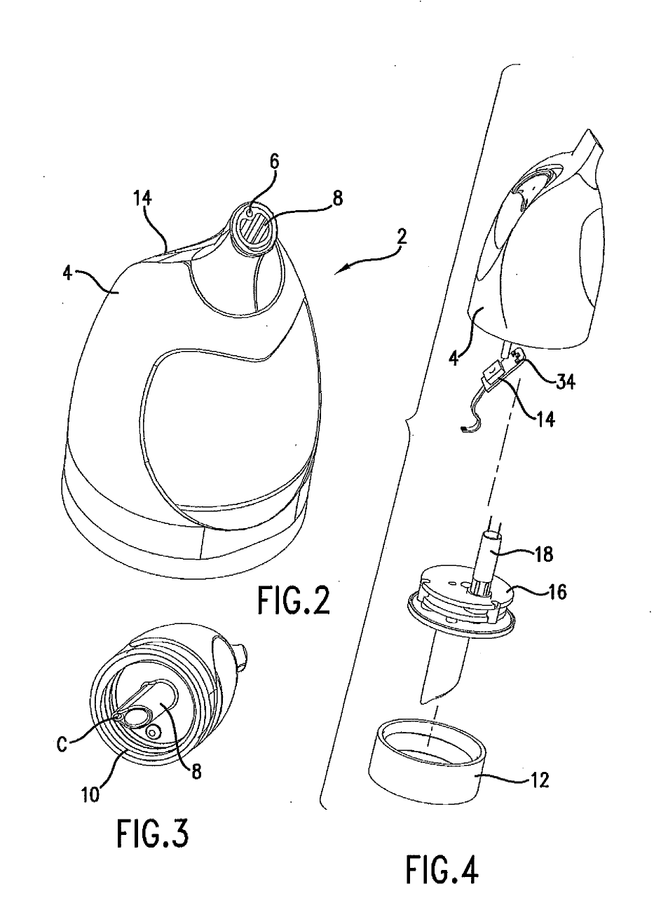

Turning now to the drawing figures, FIG. 2 shows an embodiment of the dosing spout 2. The dosing spout has a housing 4. An upper portion of the housing has an opening that permits an air inlet tube 6 to communicate with air outside of the housing, and a liquid outlet tube 8 that has an opening to an outside of the housing for dosing the liquid from the spout. As shown in FIG. 3, the air inlet tube extends through the housing to a lower portion of the housing. The liquid outlet tube also extends through the housing to a lower portion of the housing. The portion of the air inlet tube and the liquid outlet tube shown in FIG. 3 is positioned in an upper end of a container to which the dosing spout is attached.

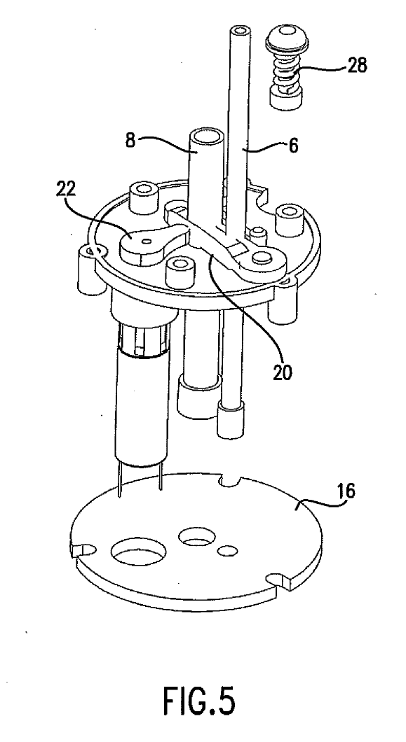

In a preferred embodiment, the dosing spout is affixed to the container by threads 10 which match threads of a container. As shown in FIG. 4, a ring 12 with inner threads may be provided. This ring has threads that match the threads of the container to which the dosing spout is to be affixed. Accordingly, the ring should be removable from the dosing spout, so that the dosing spout may be used with containers having threads of varying sizes. The ring may be replaced with a ring having threads of the specification required for the particular container.

The dosing spout is used with liquid containers of the type that are in common use. The most common container used with the dosing spout is a bottle having a neck of reduced size, with an opening in the upper end of the neck when the bottle is positioned vertically and resting on its bottom. Most containers will have external threads formed in the container neck. The container may be glass, PET or other plastics or other materials from which containers are made. Most commonly, the containers will range from 100 ml to 3 liters in size, but could be larger or smaller.

In another embodiment, the spout is retained within the container by an interference fitting, using fitting that is similar to a cork. A “cork” as used in the liquor industry is typically a resilient plastic or rubber stopper that may be tapered for entry into the container, and typically has a plurality of annular rings that provide resistance from pulling out. The interference fit and resiliency, along with the structure of the stopper, provide liquid sealing between the spout and the container.

As shown in FIG. 4, a portion control switch 14 is present in the housing. The portion control switch communicates with a microprocessor 16 that may be part of the internal control mechanism. In one embodiment, the portion control switch presents LEDs 34 that are color coded. Portion selection is performed according to color code. For example, one LED may be red, one green and one blue. The operator may select the portion to be dispensed that correlates with each color. One color may correspond to one (1) ounce of liquid, another color corresponds to one-and-one-half (1½) ounces of liquid, while a third color corresponds to two (2) ounces of liquid. Additional colors and dosages may be included in the devices as required by the application.

The internal mechanism is present in the body. The internal mechanism includes a motor 18, a pinch valve 20 and associated actuator, and the micro-processor 16.

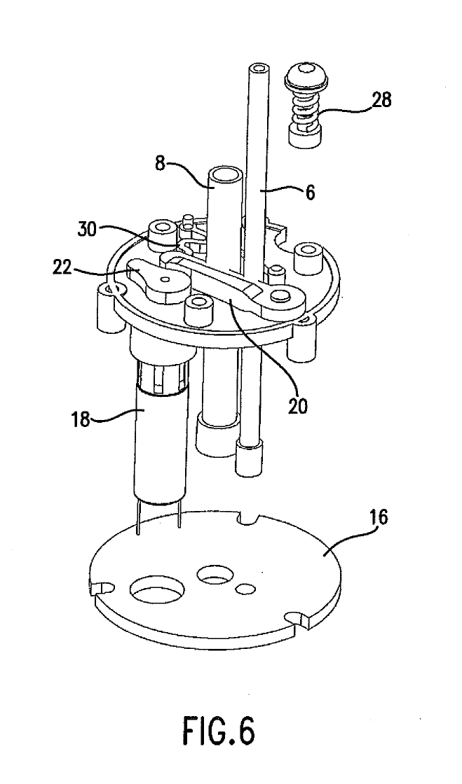

FIG. 5 shows the internal mechanism according to a preferred embodiment. The internal mechanism as shown comprises a motor, a pinch valve, and a cam 22 that is rotated by the motor to operate the pinch valve. In this embodiment, the pinch valve is forced by the cam against the air inlet tube and the liquid outlet tube, to pinch and close a lumen that is present in each of the air inlet tube and the liquid outlet tube. The air inlet tube and liquid outlet tube are formed of a resilient material which allows each of them to be closed by pinching the tubes to restrict air flow and liquid flow, respectively, through the lumens of the tubes. The tubes are preferred to be formed of a resilient material that has shape memory characteristics. The resilient material allows the tubes to be pinched shut, yet the tubes fully open after numerous cycles of opening and closing. In particular, tubes comprising food grade silicone are capable of rapidly opening when pressure from the pinch valve is withdrawn, and a tube comprising silicone may have sufficient shape memory to return to the fully open position even after the opening and closing cycle is repeated numerous times.

FIG. 5 shows the pinch tube holding the air inlet tube and the liquid outlet tube in the normal position, which is the closed position. When the container is in a generally vertical position, that is, when the longitudinal axis of the container is in a generally vertical position, the cam holds the pinch valve in position against the air inlet tube and the liquid outlet tube, so that the air inlet tube and liquid outlet tube are pinched to a closed position.

In this embodiment, portion or dosing control is achieved by opening and closing the air inlet tube. Spring biasing forces the pinch valve away from the air inlet tube as pressure from the cam is released.

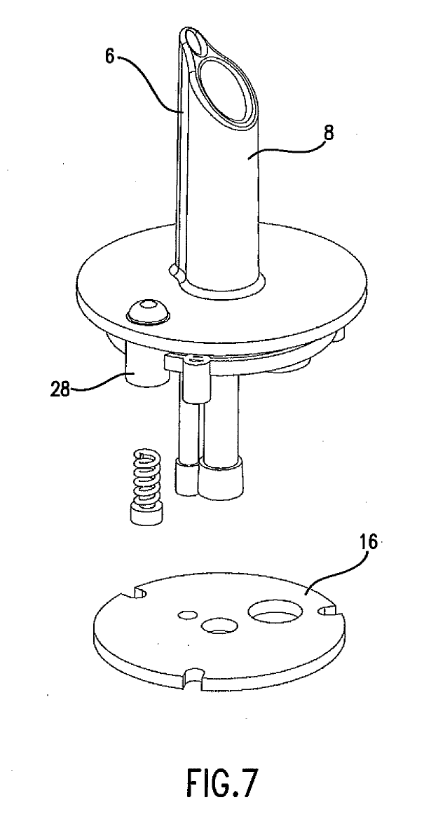

In a preferred embodiment, the pinch valve is attached to the liquid outlet tube. By attaching the pinch value to the liquid outlet tube, opening of the liquid outlet tube is assured, as the retreating pinch valve pulls the liquid outlet tube with it. FIG. 6. If liquids having a sticky consistency are dispensed through the dosing spout, the pinch valve, by spring biasing action, will insure that the liquid outlet tube opens fully to dispense the proper dosage.

In a preferred embodiment, the motor rotates the cam to force the pinch valve 20 or the tab 160 of the lever arm against the air inlet tube. The air inlet tube is in the normally closed position. The pinch valve is constructed and arranged so that, as the pinch valve is moved by the cam to the normally closed position, the air inlet tube is closed slightly before the liquid outlet tube is closed. This operation is believed to enhance accurate portion control by the device. Dosing and portion control results from opening and closing the air inlet tube. However, particularly as the liquid level decreases in the bottle, the quantity of air in the container increases. In some containers, and with some liquids, as the quantity of air increases, there is an increased tendency for the liquid to drip after the air inlet tube is closed. Accordingly, in a preferred embodiment, the liquid outlet tube is closed by the pinch valve to inhibit dripping.

As the container is tilted to a position which allows liquid to flow into the liquid dispensing tube, an angle detection device 24, or accelerometer, or inclinometer, notes a change in the position of the container from a vertical position to an angle that, in a preferred embodiment, approaches a horizontal position. The angle detection device sends a signal, preferably through the microprocessor, for the motor to rotate the cam to the position shown in FIG. 6, thereby opening the air inlet tube, and in some embodiments, the liquid outlet tube, subject to liquid being available to the liquid outlet tube. The angle detection device may be a 3 axis accelerometer from Freescale Electronics, that comprises auto wake/sleep, orientation detection, and gesture detection (including shake and tap detection).

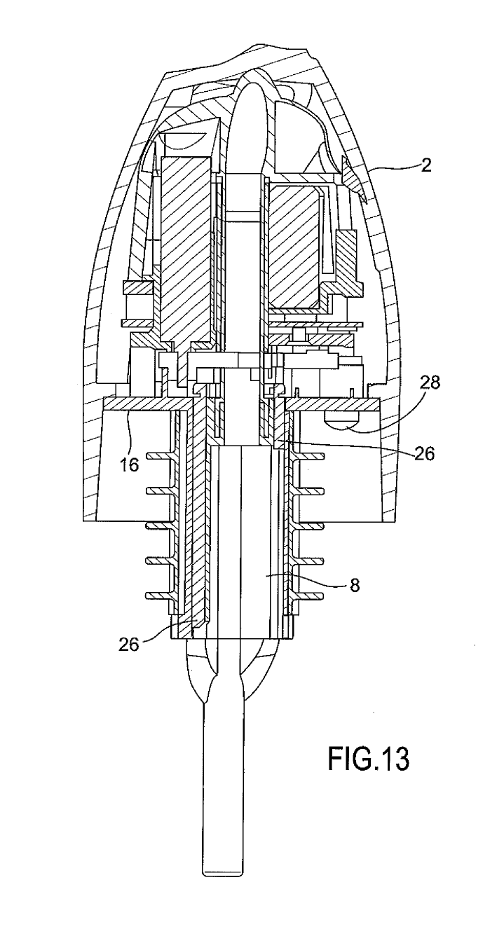

A liquid detect 26 detects the presence or absence of liquid available to the liquid outlet tube. FIG. 13. If the angle detection device detects an appropriate angle, and there is liquid available to the liquid outlet tube, a switch is closed which causes the motor to rotate the cam to the position shown in FIG. 6. The spring arm portion of the lever 30 pushes the pinch valve to open the lumen in the air inlet tube, and in some embodiments, the liquid outlet tube, and liquid flows through the liquid outlet tube and out of the spout. The angle at which the neck of the container, and subsequently the liquid outlet tube, will receive and fill with liquid depends on the quantity of liquid remaining in the container. In one embodiment, the angle detection device signals to actuate the motor when the container is inverted, and the opening of the container reaches 30° to 45° below horizontal.

In a preferred embodiment, the angle detection device will signal to actuate the motor when the container opening reaches an inverted position. An inverted position means that the axis of the opening of the container (which, for most containers, is generally coaxial with the longitudinal axis of the container) is below horizontal. In use, the container is usually stored in a vertical position with the axis of the opening, and usually, the longitudinal axis of the container, in a vertical position. The operator picks up the container and tilts it to, and through, a horizontal axis of the opening, until the opening is below horizontal. At most fill levels, liquid is introduced and is available to the liquid outlet tube, and the angle detection device and liquid detect device signal to actuate the motor, opening the air inlet tube and the liquid outlet tube as described herein to dispense the liquid. If the liquid level is so low that further tilting of the bottle toward an inverted position is necessary, the process of opening the tubes is not initiated until the liquid detect device detects that liquid is available to be dispensed.

After a predetermined period of time, the motor rotates the cam to push the pinch valve back into the normally closed position of FIG. 5 terminating the flow of air through the air inlet tube, which in turn terminates the flow of liquid through the liquid outlet tube, since there is no air pressure available to permit a flow of liquid from the liquid outlet tube. The time that the pinch valve is in the position shown in FIG. 6, permitting the flow of air into the container, and liquid out of the container, is chosen according to the required dosage or quantity of liquid to be dispensed. This predetermined time will be varied by the selection on the portion control switch, with a larger portion or dosage corresponding to a longer time interval during which the pinch valve is in the position of FIG. 6. However, dosage is a also a function of the viscosity of the liquid, and the predetermined time that the air inlet tube is open is also determined and programmed according to known viscosities of particular liquids. For example, vodka has a lower viscosity than certain liqueurs, particularly milk-based liqueurs. However, these viscosities are known, and can be programmed to the dosing spout as required.

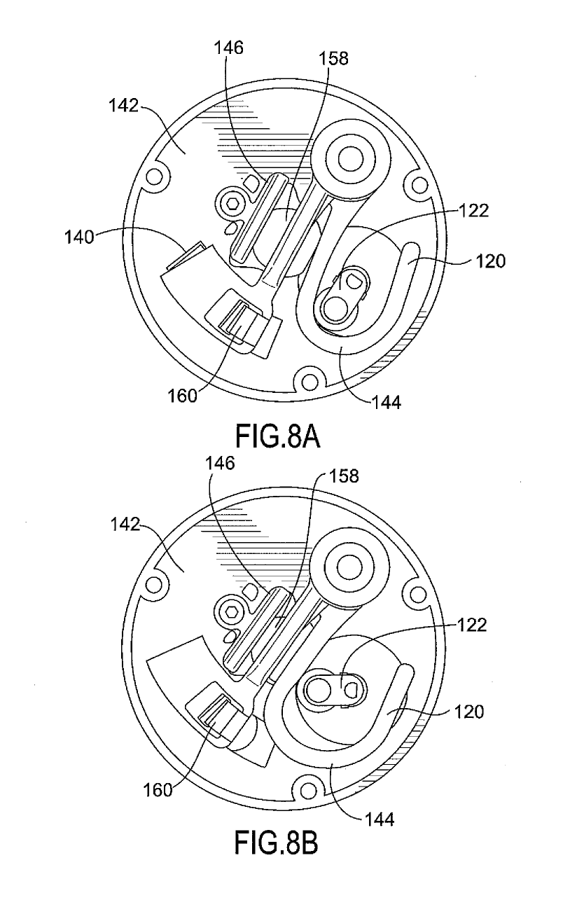

In a preferred embodiment, the device comprises a bottle or container detect actuator. FIG. 7. The container detect actuator may be a switch 28. In this embodiment, unless the container detect actuator switch is closed, the device cannot be operated. The container detect actuator may be a pressure switch that is closed by pushing a button on the bottom of the actuator upward, which will occur as the device is threaded onto the container. The wireless signal incorporated into the device sends a signal to the central processor indicating that the dosing spout is affixed to the container, while also signaling when the dosing spout is removed from the container. This signal may be actuated by the container detect actuator, which is preferred to communicate with the microprocessor. An alert may be sent if the overall quantity dispensed through the dosing spout does not correspond to the original quantity of liquid in the container. For example, if the spout is removed from the container before all of the liquid is dispensed, a signal is sent to the central processing unit. This prohibits the operator from removing the dosing spout to pour liquid from the container, and bypassing communication of dosing information.

In some instances the operator will wish to dispense multiple doses without returning the container to the vertical position. In one embodiment, after the cam is actuated to return to the normally closed position after a predetermined time to terminate liquid flow, the cam rotates by operation of the motor, and the spring forces the pinch valve to open the air inlet. The spout resumes dosing. The pinch valve, after predetermined time and associated dosage, returns to the normally closed position. This cycle can be repeated multiple times according to one embodiment, as long as the angle detection device does not detect that the container has been returned to a more vertical position, and as long as liquid is available for the liquid outlet tube. By way of example, if an operator wishes to dispense three consecutive doses of a beverage into three glasses, the operator can tilt the bottle. The angle detection device and liquid detect device will send a signal to actuate the motor, moving the cam and allowing the pinch valve to open the air inlet tube and liquid outlet tube for the predetermined time. After the first dose is dispensed, the pinch valve, by actuation of the motor and cam, will briefly close the air inlet tube and liquid outlet tube, then reopen for a second dose. This cycle is repeated for a third dose, and will occur as long as the container is held in a position that will actuate the angle detection device and the liquid detect device.

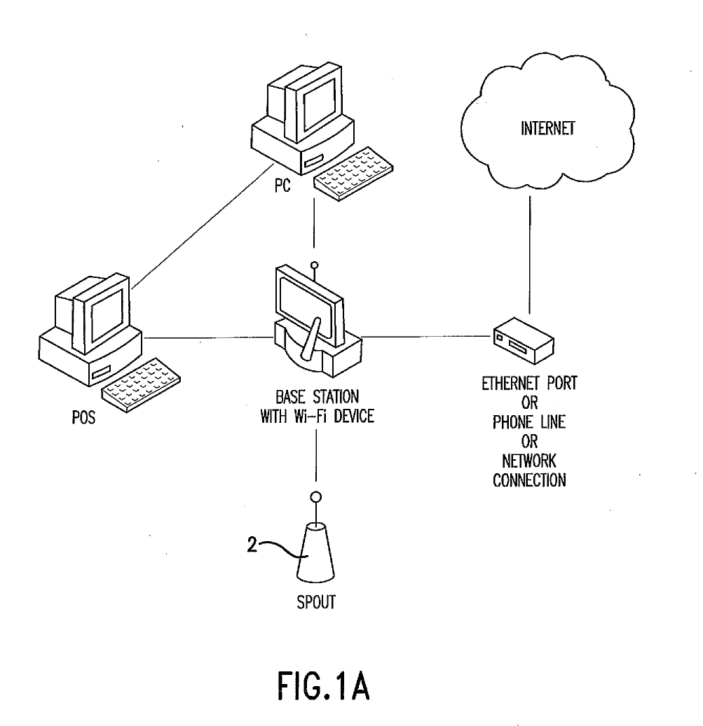

In a preferred embodiment, the dosing spout comprises a microprocessor and a wireless transmitter 32. The microprocessor may be contained in the device as shown in the drawing figures. The wireless transceiver communicates with a central processing unit or system. As shown in FIG. 1A, a wireless receiving device communicates with one or more processors, which may be personal computers, or which may be other larger remote computers that are available for connection, such as connection via the Internet. The system may receive wireless signals from multiple dosing spouts, and record events such as pour events as received from each of the dosing spouts.

It is preferred that that device have a default to a preferred predetermined pour (air inlet tube open) time. For example, if the operator's last selection is three (3) ounces, the device will default to one (1) ounce after the container is returned to the vertical position.

A preferred embodiment has a “Last Pour Memory”. If a requested portion is not completed; the dosing spout will cause this event to be stored in memory and will complete the pour from the next bottle. Last Pour Memory may have a programmable “time out” feature of, for example, 1 to 10 minutes. A liquid detect 26 is provided in a lower portion of the liquid outlet tube that is preferably on the container side of base plate 16,116, and is downstream of the mechanism that opens and closes the liquid outlet tube. FIG. 13. If no liquid is present in the liquid outlet tube, the liquid detect will terminate operation of the device, even if the container or bottle sensor has actuated operability the spout and the angle detection sensor signals the device to open the air inlet tube and liquid outlet tube. If termination by the liquid detect is prior to a complete pour cycle, Last Pour Memory is actuated, and the pour is completed when, for example, a container having liquid therein is fitted to the same spout, such as a new or full bottle of liquid.

The liquid detect may be a conductive sensor, wherein the liquid in the liquid outlet tube completes a circuit between two points. The liquid detect 26 therefore has two conductive points or contacts that are spaced apart from each other, with one point or contact preferably positioned higher than the second point or contact and within the liquid outlet tube. FIG. 13. The liquid completes the circuit and allows current to flow between the points or contacts, permitting the device to operate upon being actuated by the angle detection device or sensor.

The device may therefore detect a partial pour with the Last Pour Memory feature. Partial pour may occur as a result of either giving a “splash” or under pouring, such as when the container has an insufficient amount of liquid to complete the pour. A programmable percentage “splash” level, below which the pour will be ignored, may be incorporated. A default level for the splash may be as programmed, such as about 10% of current selected shot size. If the container contains less a certain amount of liquid, for example, 1 ounce, and a pour selection of 2 ounces is requested by a selection on the spout the following exemplary process occurs. As a bottle is moved to a pouring angle, bottle angle detection is engaged, and the liquid detect senses liquid, causing actuation of the motor. The device cycles to deliver the requested pour (2 ounces). When the contents (1 ounce) is exhausted, the liquid detect will lose conductivity and report that the bottle is empty. The spout calculates that only one (1) ounce was poured. The spout may initiate a timer per the firmware/software to allow time to insert the spout into a fresh bottle having the required liquid therein. When replaced on the fresh bottle within the time allowed, the spout will then pour the additional ounce of liquid. The spout returns to normal operation as long as it remains on that bottle, and as long as liquid contents of the bottle are present.

A programmable percentage “under pour” level, at or above which the pour will be considered a full shot, may be incorporated. For example, about 90% of current selected shot size may be considered a full pour. Any shot size measured in the range above the “splash” and below the “under pour” may generate an alert signal.

The dosing sprout may use wireless connectivity to a base station. The base station may detect if the spout is out of range. The dosing spout may store pour events that have not been successfully transmitted to a wireless access point, such as a base station or processor, and communicates those events when the communications link is reestablished. The base station may have personal computer or smart phone access for system configuration and report printing. Web based reports may be used. It is preferred that all pour events and reports are time stamped to provide security, control, and accountability.

The spout is preferred to be a battery powered device. Remaining battery life estimates may be sent to the base station or processor. The spout may have a battery life indicator as reported by the LED interface. The battery or batteries that power the spout may be rechargeable, and the spout may be placed in a charger configured to accept the spout without removal of the batteries.

For each pour event, and for each dosing spout in the system, it is preferred that a message will be sent to or logged by the base station or processor. Data sent or recorded for each pour event may include:
time and/or timing of the pour cycle.
the volume of each pour and an aggregate volume, such as the aggregate volume for the current container, or for a period of time.
selected liquid type or class.
operator identifier.
location identifier.
container size, which many include a default size.
if free pour is available, the volume of the pour.
monetary value for pour event, and for an aggregate of pour events.

Pricing options may be provided according to time of day, such as periods of special pricing. A calendar may be programmed for special events or holidays. Unique or special pricing may be applied to pour events within those defined times or dates.

When the container is tilted into the pour position and the liquid detect device detects a lack of liquid, an “empty container” status may be sent to the base station or processor. Further, information may include the last pour time, status of last pour (such as, was the last poor completed before the container was changed, or remains to be completed), liquid type or class, operator identification, and location of the spout. The device may also compute the number of shots poured from the container.

A cleaning event alert may also be communicated to the spout, and logged by the processor. The spout, when in the cleaning mode, places the pinch valve in the open position. The cleaning mode may activate, and may remain activated, when the spout is disengaged from the container. The cleaning mode may deactivate when the spout is reengaged with a container. In one embodiment, when the spout is disengaged from a containers and a portion selection button is depressed and held for a predetermined time, the cleaning mode is activated. The cleaning mode is deactivated when the container detect actuator senses that the spout is engaged with a container. If the spout is removed from a partial container for cleaning, then reengaged, when the portion selection button is depressed and held for a predetermined time, the spout will resume its count of the partial container as of the count when the spout was removed.

Container movement during defined times, such as business closed hours, is detected and logged. The times for detecting container movement are user selectable and may be wirelessly communicated to some or all spouts.

When a new container is installed, the spout momentarily (for example, ½ second) opens the valve to relieve pressure resulting from inserting the spout into the container. A residue release is used for the dispensing of thick or creamy products. When residue release is selected, the spout is open momentarily (for example, % second) after returning to the upright or vertical position to allow residue to return to the container.

The spout is preferred to have an automatic shutoff and a “sleep” mode. If the spout is not used to dispense liquid in within a predetermined time, the spout will shutoff or go into sleep mode. The time interval for shutoff may be user selectable. If the spout is removed from the container, the removal is wireless reported by the system and the event is recorded. The automatic shutoff is time actuated, with the actuation time selected by the user. The automatic shutoff may actuate, for example, at closing time of a restaurant, so that no more liquid may be dispensed after closing time. The shutoff allows pouring to resume at another preset time, such as when the restaurant opens.

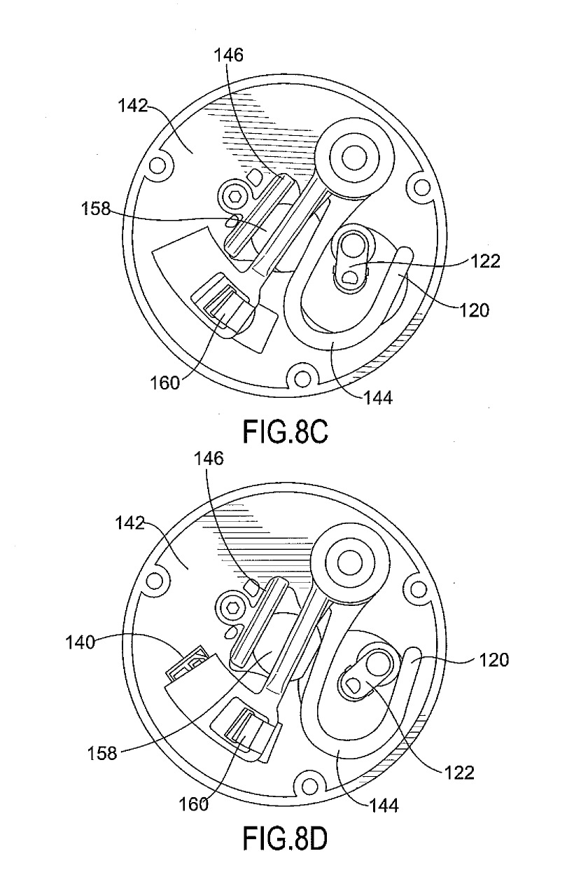

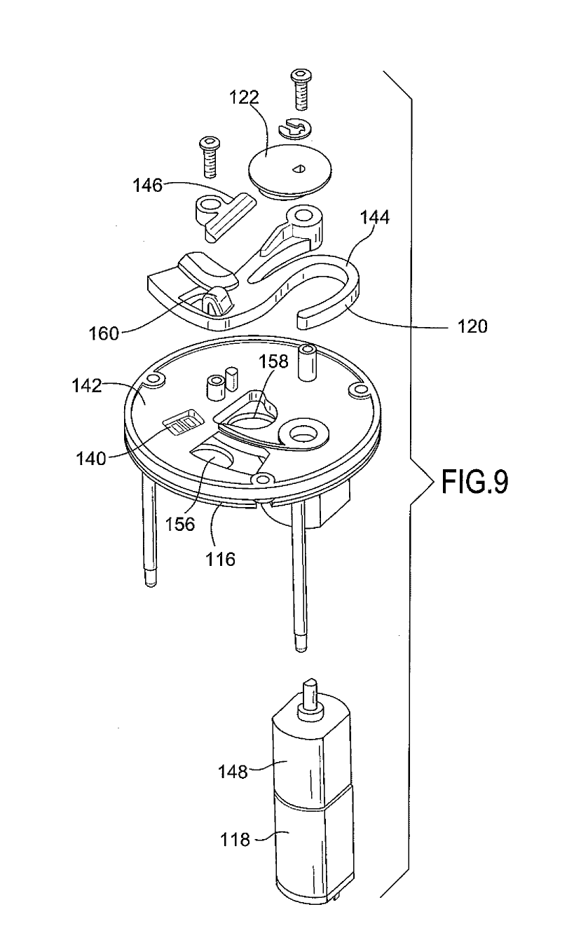

FIGS. 8A, 8B, 8C, 8D, 9, 10, and 11, show an alternate embodiment of the internal mechanism of the device that is present in the body. System operations are the same as previously discussed embodiments. The exploded view (FIG. 9) shows elements of this embodiment. A base plate 142 as shown has an opening 156 for the air inlet tube 106 and an opening 158 for the liquid outlet tube. The base plate has a window for an optical sensor 140. A processor 116 is positioned under the base plate, as described in the embodiment above. Motor 118 having a gear box 148 is mounted to a cam 122 through the base plate. Lever arm 120 is pivotally mounted to the base plate. The lever arm has a crook portion 144 in which the cam rotates. The crook may open to either side (Compare FIG. 8A to FIG. 9). A follower 146 is pivotally mounted to the base plane, and acts as a stop or pressure receiver as the lever arm pushes from an opposite side against the liquid outlet tube. The lever arm has a flexible tab 160 that is moved by the cam and lever arm to close the air inlet tube. The flexible tab deforms to maintain pressure for a slightly extended period of time after the cam moves away from the lever arm. The pivot points of the cam and lever arm may be held vertically in place with fasteners such as screws, while allowing pivoting.

Cam 122 is rotated by the motor to operate the lever arm, which acts as a pinch valve. In this embodiment, the pinch valve is forced by the cam against the air inlet tube 106 and the liquid outlet tube 108, to pinch and close a lumen that is present in each of the air inlet tube and the liquid outlet tube.

As with other embodiments of this invention, the air inlet tube and liquid outlet tube are formed of a resilient material which allows each of them to be rapidly closed by pinching the tubes to restrict air flow and liquid flow, respectively, through the lumens of the tubes. The liquid outlet tube is of much smaller diameter than the air inlet tube, the air inlet tube having about 20-30% of the flow area of the liquid outlet tube. Rapid closing of air inlet tube will quickly terminate liquid flow through the liquid outlet tube. The tubes are preferred to be formed of a resilient material that has shape memory characteristics. The resilient material allows the tubes to be pinched shut, yet the tubes fully open after numerous cycles of opening and closing. In particular, tubes comprising food grade, low durometer silicone are capable of rapidly opening when pressure from the pinch valve is withdrawn, and a tube comprising silicone may have sufficient shape memory to return to the fully open position even after the opening and closing cycle is repeated numerous times.

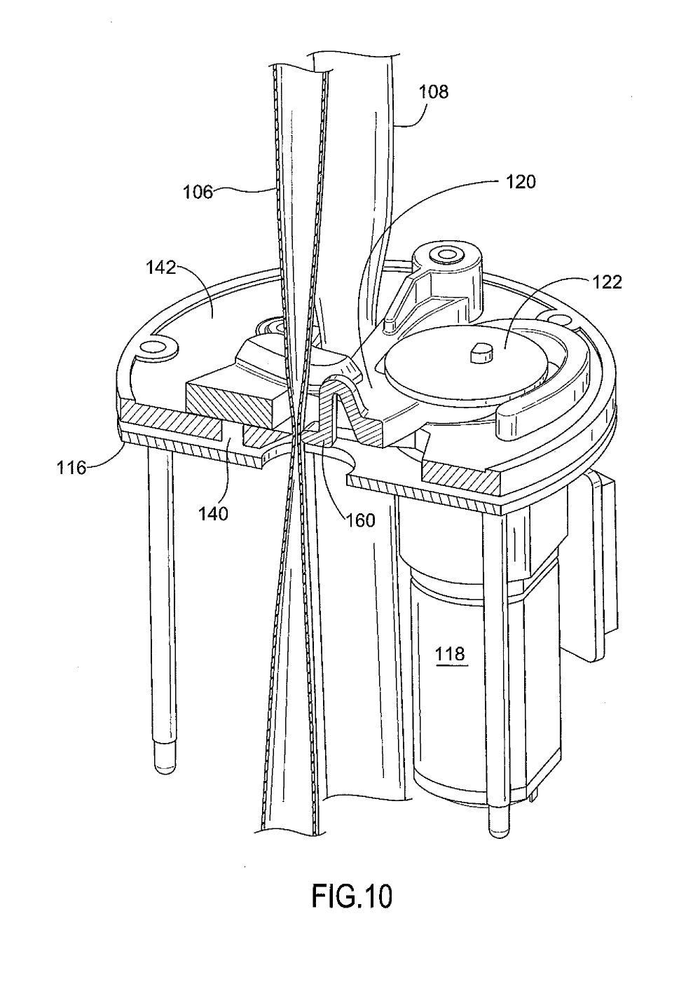

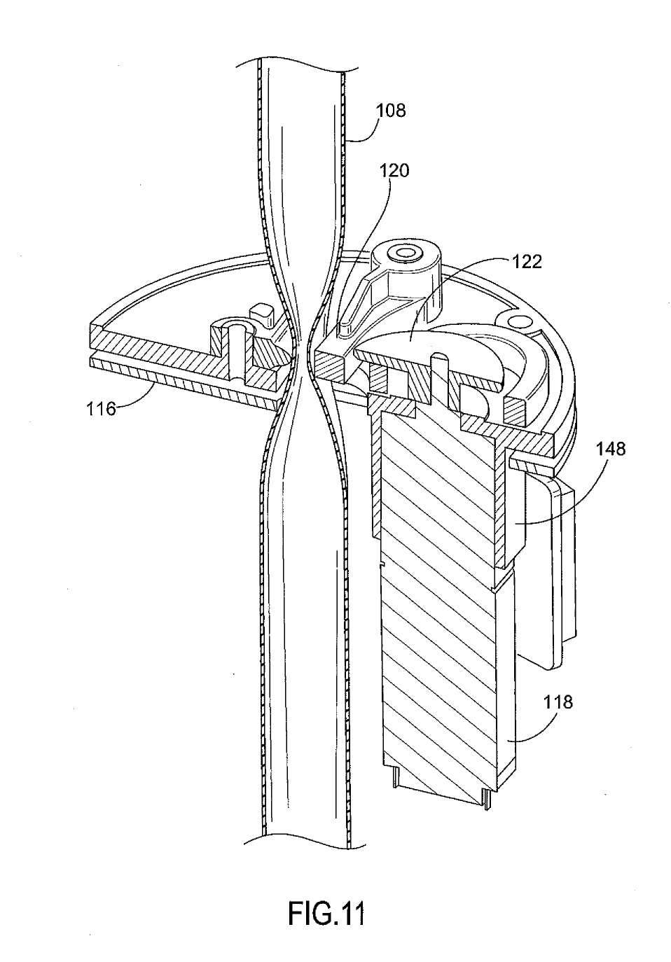

FIG. 10 shows the lever arm holding the air inlet tube in the normal position, which is the closed position. FIG. 11 shows the lever arm holding the liquid outlet tube in the normal position, which is the closed position. When the container is in a generally vertical position, that is, when the longitudinal axis of the container is in a generally vertical position and the bottle is sitting on its bottom, the cam holds the pinch valve in position against the air inlet tube and the liquid outlet tube, so that the air inlet tube and liquid outlet tube are pinched to a closed position. FIG. 8B. In this embodiment, portion or dosing control is preferred to be achieved by opening and closing the air inlet tube.

In a preferred embodiment, the motor rotates the cam. The cam pushes the lever arm to force the pinch valve against the air inlet tube by pushing the flexible tab 160 against the air inlet tube 106 that extends through the opening 156 in the base plate. The air inlet tube is in the closed position, which is the normal position. FIG. 8B. The lever arm/pinch valve is constructed and arranged so that, as the lever arm/pinch valve is moved by the cam to the normally closed position, the air inlet tube is fully closed slightly before the liquid outlet tube is fully closed. This operation is believed to enhance accurate portion control by the device. Dosing and portion control results from opening and closing the air inlet tube. However, particularly as the liquid level decreases in the bottle, the quantity of air in the container increases. In some containers, and with some liquids, as the quantity of air increases, there is an increased tendency for the liquid to drip after the air inlet tube is closed. Accordingly, in a preferred embodiment, the liquid outlet tube is fully closed by the pinch valve after the air inlet tube is fully closed to inhibit excess dripping. The cam acts on the portion of the lever arm that closes the air inlet tube before it acts on the portion of the lever arm that acts on the liquid outlet tube, so as to close the air inlet tube before closing the liquid outlet tube.

As the container is tilted to a position which allows liquid to flow into the liquid dispensing tube, the angle detection device 24, or accelerometer, or inclinometer, notes a change in the position of the container from a vertical position to an angle that, in a preferred embodiment, approaches a horizontal position. The angle detection device sends a signal, preferably through the microprocessor, for the motor to rotate the cam. The cam rotates through the positions shown in FIG. 8C, FIG. 8D and FIG. 8A, thereby opening the air inlet tube, and the liquid outlet tube. A liquid detect device 26 detects the presence or absence of liquid available to the liquid outlet tube. If the angle detection device detects an appropriate angle, and there is liquid available to the liquid outlet tube, a switch is closed which causes the motor to rotate the cam. The angle at which the neck of the container, and subsequently the liquid outlet tube, will receive and fill with liquid depends on the quantity of liquid remaining in the container. In one embodiment, the angle detection device signals to actuate the motor when the container is inverted, and the opening of the container reaches 30° to 45° below horizontal.

In a preferred embodiment, the angle detection device signals to actuate the motor when the container opening reaches an inverted position. An inverted position means that the axis of the opening of the container (which, for most containers, is generally coaxial with the longitudinal axis of the container) is below horizontal. In use, the container is usually stored in a vertical position with the axis of the opening, and usually, the longitudinal axis of the container, in a vertical position. The operator picks up the container and tilts it to, and through, a horizontal axis of the opening, until the opening is below horizontal. At most fill levels, liquid is introduced and is available to the liquid outlet tube, and the angle detection device and liquid detect device signal to actuate the motor, opening the air inlet tube and the liquid outlet tube as described herein to dispense the liquid. If the liquid level is so low that further tilting of the bottle toward an inverted position is necessary, the process of opening the tubes is not initiated until the liquid detect device detects that liquid is available to be dispensed.

After a predetermined period of time, the motor rotates the cam to push the pinch valve back into the normally closed position of FIG. 8B, terminating the flow of air through the air inlet tube, which in turn terminates the flow of liquid through the liquid outlet tube, since there is no air pressure available to permit a flow of liquid from the liquid outlet tube. The time that the air inlet tube and the liquid outlet tube are open permitting the flow of air into the container, and liquid out of the container, is chosen according to the required dosage or quantity of liquid to be dispensed. This predetermined time will be varied by the selection on the portion control switch, with a larger portion or dosage corresponding to a longer time interval during which the tubes are open. However, dosage is a also a function of the viscosity of the liquid, and the predetermined time that the air inlet tube is open is also determined and programmed according to known viscosities of particular liquids.

FIGS. 8A, 8B, 8C, 8D, show rotation of the motor and cam. The lever arm 120 is shaped with an arcuate end that the cam 122 rotates within, and acts upon. In FIG. 8A, the cam is positioned within a crook of the lever arm. The cam positions the lever arm so that the lever arm contacts the liquid outlet tube, but the liquid outlet tube is open. The air inlet tube is beginning to close, and is mostly closed, as is revealed by the position of the lever arm relative to the window 140 for the optical sensor.

In FIG. 8B, the cam is positioned so as to push against the lever arm and push the lever arm toward the liquid outlet tube and the air inlet tube. The cam positions the lever arm so that the lever arm closes the liquid outlet tube and the air inlet tube by pushing against the tubes 106,108. The lever arm is structured so that the crook portion deforms between the crook and the lever that extends from the point of rotation of the lever arm as the cam rotates from the position of FIG. 8A to the position of FIG. 8B, as shown in the drawing figures by the narrowing of the gap between the portions of the lever arm. This deformation delays closing of the liquid outlet tube relative to the closing of the air inlet tube. The air inlet tube closes to terminate liquid flow, with the liquid outlet tube closing slightly later so that the liquid outlet tube more completely evacuates liquid that is in it after the air inlet tube closes. The liquid outlet tube is closed to prevent excess dripping and evaporation. The position of FIG. 8B is the normal, closed position of the device when not in use for dispensing liquid from the associated container.

The outer driving surface of the cam and the lever arm cooperate so that as the cam rotates, the cam pushes against an edge of the lever arm that is curved around the cam to form a crook, and moves an edge of the lever arm into engagement with the outside diameter of the pliable liquid outlet tube. FIG. 11. A portion of the lever arm is deformable as shown in the drawings, and acts as a spring arm to provide a somewhat adjustable amount of compression on the liquid outlet tube to pinch the air inlet tube and the liquid outlet tube during the first half of the annular rotation of the cam. The lever arm will rotates past the point where the air inlet tube is initially closed against the opening in the base plate. With further rotation, the cam pushes the other side of the curved or crooked spring arm section of the lever arm on the second half of one rotation of the cam, as can be understood by the drawings.

Follower 146 forms a stop for the liquid outlet tube. The follower is pivotally mounted to pivot or rotate above the face of the base plate on which it is mounted. The follower conforms to the appropriate angle necessary to provide a complete and reliable closure of the liquid outlet tube with a pinch shut-off, created by the cam acting on the lever arm to squeeze the liquid outlet tube against the follower.

A motor 18, 118 used with embodiments of the invention may be a low-voltage, high speed DC motor, which receives its power from a rechargeable battery that may be located in the spout. The motor may drive an output shaft via a series of several planetary gears 148, having a gear ratio of, for example, 1:150. The result of the gear ratio is a slowly rotating output shaft having relatively high torque. Cam 122 is driven by the output shaft.

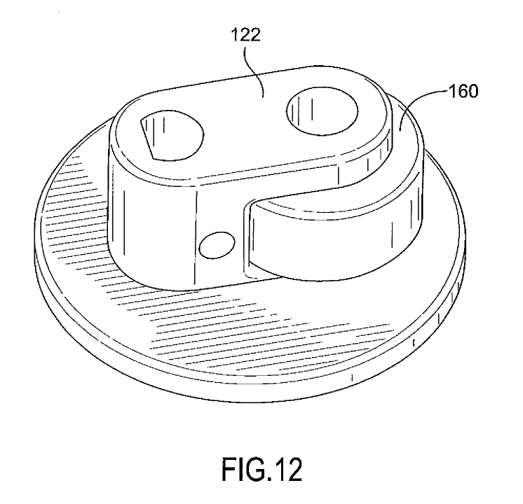

The cam rotates to the point of maximum interference or squeeze against the liquid outlet tube. An embodiment of the cam that may be used with the invention is shown inverted in FIG. 12. Desired dwell time is achieved by a flattening of the cam at the apex of its travel provides some leeway or tolerance for an otherwise immediate and instantaneous shut down requirement for electrical power to the motor to effect holding the pinch valve in the closed position. The embodiment of the cam shown in FIG. 12 has a roller 162 to reduce friction against the lever arm 120 or pinch valve 20. The components as described cooperate to close the air inlet tube first and shortly thereafter close the liquid outlet tube to retard dripping at the conclusion to a pour.

Switching of the motor is primarily signaled by an optical sensor 140 communicating with a processor 116 that may be positioned underneath the base plate. The optical sensor receives light through an opening in the base plate that is selectively opened and closed by movement of the lever arm. When the cam positions the lever arm to achieve closure of the tubes, the optical sensor 140 is preferred to be completely covered by an end of the lever arm. The optical sensor has an emitter portion and a collector portion, as shown. FIG. 9. When the emitted signal from the optical sensor is reflected back from the underside of the lever arm to the collector portion of the sensor, that event informs the electronic system precisely when the lever arm has reached its “closed” position, and the motor power is then switched off by the control system. Also at that time, other factors, such as bottle position or time, as previously disclosed, determine how long the pinch valve remains closed before it is re-opened to start the next pour.

After the control system switches the motor on, the motor continues to rotate through a single orbit, advancing the cam in the same direction. In a preferred embodiment, the motor rotation is not required. Further rotation of the cam pushes on the opposite curved surface or crook of the lever arm. The flat surface of the lever arm pulls away from the liquid outlet tube and follower, opening the liquid outlet tube and then the air inlet tube, initiating liquid flow.

Power to the motor may be interrupted for a predetermined time by the electronic control system at the fully-open position, which allows the device to dispense precisely the desired amount of liquid. The processor may be programmed to account for liquid viscosity, selected pour volume, and various other parameters such as the pour angle, as described herein.

What is claimed:

1. A system for controlling liquid dosing from a plurality of containers, comprising:
a plurality of spouts, wherein each spout is constructed and arranged for insertion into and removal from an opening of a container;
a plurality of wireless transmitters, wherein each of the plurality of wireless transmitters is associated with one of the spouts of the plurality of spouts, and each of the plurality of spouts transmits data about a pouring cycle of the spout of the plurality of spouts with which the wireless transmitter is associated;
a computer having a wireless receiver that receives data from the plurality of wireless transmitters about the pouring cycle of each of the spouts;
wherein, the computer computes information from data received from the plurality of wireless transmitters and the computer stores the information;
wherein, each spout comprises a microprocessor and a real time clock, and wherein each spout transmits data by its associated wireless transmitter to the computer about pour cycles of the spout.

2. A system for controlling liquid dosing from a plurality of containers as described in claim 1, wherein each spout of the plurality of spouts comprises an angle detection device, and wherein, upon a change of angle of a container that directs liquid from the container into the spout associated with the container, the angle detection device of the spout actuates an actuator that opens an air inlet tube, and after a predetermined event, the actuator closes the air inlet tube, and the spout transmits to the computer a count of a pour cycle by the spout.

3. A system for controlling liquid dosing from a plurality of containers as described in claim 1, wherein each spout of the plurality of spouts comprises a selector on an exterior of the spout, the selector comprising three positions, wherein each position correlates to a volume of liquid dispensed by the spout during a pour cycle.

4. A system for controlling liquid dosing from a plurality of containers as described in claim 1, wherein each spout of the plurality of spouts comprises a selector on an exterior of the spout, the selector comprising three positions, wherein each position of the three positions correlates to a volume of liquid dispensed by the spout during a pour cycle, and wherein each position of the three positions is identified by a color that is visually distinguishable from each remaining position.

5. A system for controlling liquid dosing from a plurality of containers as described in claim 1, wherein the computer calculates, for a defined time period, the number of pour cycles by each spout of the plurality of spouts, the volume of liquid dispensed during each pour cycle by each spout of the plurality of spouts, the aggregate number of pour cycles by the plurality of spouts, and the aggregate volume of liquid dispensed by the plurality of spouts.

6. A system for controlling liquid dosing from a plurality of containers as described in claim 1, wherein the computer computes a monetary price for each pour cycle and provides the monetary price to a point of sale device.

7. A system for controlling liquid dosing from a plurality of containers as described in claim 1, wherein when a spout of the plurality of spouts is inserted into an opening of a container of liquid, the computer: records the volume of liquid in the container of liquid; counts the number of pour cycles of the spout while the spout is present in the opening of the container; calculates an aggregate volume of liquid dispensed from the container, and reports a calculated pour cycle when the liquid in the container is depleted.

8. A system for controlling liquid dosing from a plurality of containers as described in claim 1, wherein, when a container associated with a spout of the plurality of spouts is returned to an upright position, a liquid outlet tube of the spout opens for a predetermined time and subsequently closes while the container is in an upright position.

9. A system for controlling liquid dosing from a plurality of containers as described in claim 1, wherein each spout of the plurality of spouts comprises an angle detection device, and wherein, upon a change of angle of a container that directs liquid from the container into the spout associated with the container, the angle detection device of the spout actuates an actuator that opens an air inlet tube, and after a predetermined event, the actuator closes the air inlet tube, and the spout transmits to the computer a count of a pour cycle by the spout, and wherein during a predetermined period of a day the air inlet tube remains closed upon the change of angle of the container that directs liquid from the container into the spout.

10. A system for controlling liquid dosing from a plurality of containers as described in claim 1, wherein each spout of the plurality of spouts comprises an angle detection device, and wherein, upon a change of angle of a container that directs liquid from the container into the spout associated with the container, the angle detection device of the spout actuates an actuator that opens an air inlet tube, and after a predetermined event, the actuator closes the air inlet tube, and the spout transmits to the computer a count of the number pour cycles by the spout based upon the time that the air inlet tube is open.

11. A system for controlling liquid dosing from a plurality of containers as described in claim 1, wherein each spout of the plurality of spouts comprises a motion detector, and wherein during a predetermined period of a day an air inlet tube of the spout remains closed upon the motion sensor sensing motion of the spout, and upon removal of the spout from the container, the spout transmits information regarding removal of the spout to the computer.

12. A system for controlling liquid dosing from a plurality of containers, comprising:
a plurality of spouts, wherein each spout is constructed and arranged for insertion into and removal from an opening of a container, wherein each spout comprises a liquid sensor positioned in a liquid outlet tube and an angle detection device;
a plurality of wireless transmitters, wherein each of the plurality of wireless transmitters is associated with one of the spouts of the plurality of spouts, and each of the plurality of spouts transmits data about a pouring cycle of the spout of the plurality of spouts with which the wireless transmitter is associated;
a computer having a wireless receiver that receives data from the plurality of wireless transmitters about the pouring cycle of each of the spouts;
wherein each spout is actuated by a container detect actuator that senses that the spout is positioned in an associated container, and wherein the angle detection device of each spout senses a change of angle of the associated spout and the liquid sensor senses a presence of liquid in the liquid outlet tube, and wherein, when the container detect actuator senses that the spout is positioned in an associated container and the angle detection device senses that the spout is positioned at a required angle, and the liquid sensor senses the presence of liquid in the liquid outlet tube, the spout permits the pouring cycle comprising a measured flow of liquid from the container through the spout.

13. A system for controlling liquid dosing from a plurality of containers as described in claim 12, wherein the liquid sensor comprises a first element and a second element that is spaced apart from the first element, and wherein a circuit is completed between the first element and the second element by conductivity of current through liquid present in the liquid outlet tube.

14. A system for controlling liquid dosing from a plurality of containers as described in claim 12, wherein, when the angle detection device senses that the spout is positioned at less than a required angle, or when the liquid sensor does not sense the presence of liquid in the liquid outlet tube, the spout terminates the pouring cycle.

15. A system for controlling liquid dosing from a plurality of containers as described in claim 12, wherein the spout permits the pouring cycle by opening an air inlet tube that communicates with the container and by opening the liquid outlet tube.

16. A system for controlling liquid dosing from a plurality of containers as described in claim 14, wherein the spout permits the pouring cycle by opening an air inlet tube that communicates with the container and by opening the liquid outlet tube, and terminates the pouring cycle by closing the air inlet tube.

17. A system for controlling liquid dosing from a plurality of containers as described in claim 12, wherein the spout permits the pouring cycle by actuating a pivoting arm that opens the liquid outlet tube, and wherein an optical sensor senses the position of the pivoting arm during the pouring cycle.

18. A system for controlling liquid dosing from a plurality of containers as described in claim 12, wherein, when the liquid sensor does not sense the presence of liquid in the liquid outlet tube, and the spout terminates the pouring cycle prior to a predetermined elapsed time for the pouring cycle, the spout records termination of the pour cycle, and the spout completes the pouring cycle during a next pour event for the spout wherein the container detect actuator senses that the spout is positioned in an associated container and the angle detection device senses that the spout is positioned at the required angle, and the liquid sensor senses the presence of liquid in the liquid outlet tube.

19. A system for controlling liquid dosing from a plurality of containers as described in claim 12, wherein the computer computes information from data received from the plurality of wireless transmitters and the computer stores the information; and wherein, each spout comprises a microprocessor and a real time clock, and wherein each spout transmits data by its associated wireless transmitter to the computer about pour cycles of the spout.
